(19) United States
(12) Patent Application Publication
(10) Pub. No.: US 2005/0025795 A1
(43) Pub. Date: Feb. 3, 2005

(54) Compounds, Compositions and methods for insect control

(75) Inventors: Mitchell Anthony DeLong, West Chester, OH (US); Doni Jessica Hatz, Loveland, OH (US); Randall Matthew McCorkle, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/630,539

(22) Filed: Jul. 30, 2003

(51) Int. Cl. A01N 43/00; A01N 43/42; A01N 25/00; A01N 43/38

(52) U.S. Cl. 424/405; 514/300; 514/214.01; 514/412; 514/547

(57) ABSTRACT

Rapidly acting compositions having vapor phase insecticidal activity comprise natural products or natural product-based materials. Further, these materials are non-petroleum based, are typically 100% biodegradable, and typically do not persist in the environment, unlike traditional pesticides. The compositions kill susceptible insects on contact in seconds, even the notoriously hardy peripleneta species. The compositions also kill insects behind cracks and crevices and when sprayed onto absorbent surfaces such as wood and plasterboard, where traditional contact insecticides work poorly or not at all. New methods of testing insecticides can be used to quantify these effects.

### CROSS REFERENCE TO RELATED APPLICATION

This application is a continuation application of prior copending International Application No. PCT/US02/05597, filed Feb. 22, 2002, designating the U.S., which claims the benefit of U.S. Provisional Application No. 60/271,584, filed Feb. 26, 2001.

### FIELD OF THE INVENTION

This invention relates to compounds, compositions, and methods for treating insect infestations. More particularly, this invention relates to compositions containing bicyclic heterocyclic compounds alone or in combination with other bicyclic heterocyclic compounds, esters, or both for treating insect infestations in wood-frame buildings with plaster and lath or drywall, or other absorbent materials.

### BACKGROUND

Traditional pesticides have remained largely unchanged since their original introduction in the United States in the 1940's. They use a non-volatile, extremely toxic “active” agent, present in ˜0.1 to ˜2% of a pressurized aerosol, and 98-99.9% an ‘inert’ vehicle, which is usually a mixture of petroleum distillates. There has been little growth and few changes in this market in the 1990's.

Traditional indoor pesticides also have a very narrow usage window, with direct contact required between the formula as applied, or its residue, and the insect. Traditional pesticides do not have vapor phase insecticidal activity. Therefore, it is an object of this invention to provide compositions that have vapor phase insecticidal activity, i.e., the composition in its vapor phase can kill insects.

Some companies have also noticed the problems with traditional pesticides and have begun marketing “bio-friendly” insecticides. However, as they are apparently still taking a traditional approach to the design and testing of materials to solve the insecticide problem, and the results that these companies have obtained is not particularly different than the results of the companies taking the traditional approach. Again, direct contact is similarly required to effect even the weak toxicity of these insecticides.

### BRIEF DESCRIPTION OF THE DRAWINGS

FIG. 1 is a photo of the test chamber for the determination of vapor-phase efficacy.

FIG. 2 is the vapor-phase curve-fit for (+) menthofuran.

FIG. 3 is a plot of the activity of various classes of esters vs their molecular weight (MWt.).

FIG. 4 is the activity of esters plotted against boiling point.

FIG. 5 shows the activity of a diformate ester (EGDF) in a dose-response calculation of its LD₅₀.

### SUMMARY OF THE INVENTION

It has been surprisingly found that several classes of active compounds that are relatively non-toxic to mammals are repellent or deadly to insects when applied in a certain manner to their environment or their bodies and as part of certain compositions.

It has been further surprisingly found that traditional assays for testing insecticidal activity are, in fact flawed in that they: 1) allow the more volatile of the components of natural extracts to be underrepresented and further 2) that they test compounds and compositions applied to glass or other non-absorbent surfaces, when, in the real-life usage conditions, many of the surfaces actually in buildings are absorbent, e.g., made of materials such as plywood, 2×4 lumber, and plaster walls and behind cracks and crevices, and 3) that the activity of compounds and compositions that require direct contact between the insect and the active compound or composition decreases dramatically when applied to absorbent surfaces.

Some of the active compounds according to this invention are naturally-occurring in foods and plants, and thus have odors which consumers find more acceptable than the distinctly “pesticide-like” odor of the traditional materials. Further, some of these naturally-occurring active compounds do not persist in the environment, unlike traditional pesticides and their carriers.

Certain low molecular weight esters have no odor at all, allowing for their use in situations where a minimal odor is desired, yet a petroleum-based product is not desired. These same esters are safe to use on plastic surfaces.

Using the new test methods according to this invention allows for the identification of other compounds having vapor phase insecticidal activity, and these test methods allow for a rapid test of actually efficacy. The new test methods are more useful than the traditional application of the active to a non-absorbent or minimally-absorbent surface (usually glass).

### DETAILED DESCRIPTION OF THE INVENTION

All U.S. Patents cited herein are hereby incorporated by reference. All percentages are by weight, unless otherwise indicated.

Definitions and Usage of Terms

The following is a list of terms, as used herein.

“Absorbent material” means any material which allows organic chemicals to penetrate within the matrix of the material. This specifically excludes glass and stone, and specifically includes, but is not limited to: paper, cloth, woods of all sorts especially the woods used in building construction, plaster, drywall, hair, fur, dirt, dust, and objects comprising these materials, living or non-living, indoors or out.

“Alkyl” is a saturated or unsaturated hydrocarbon chain having about 1 to about 8 carbon atoms, preferably about 1 to about 6, more preferably about 3 to about 6, more preferably still about 3 to about 4 carbon atoms. Alkyl chains may be straight or branched. Preferred branched alkyl have one or two branches, preferably one branch. Preferred alkyl are saturated. Unsaturated alkyl have one or more double bonds, one or more triple bonds, or both. Preferred unsaturated alkyl have one or two double bonds or one triple bond, more preferably one double bond. Alkyl chains may be unsubstituted or substituted with about 1 to about 4 substituents. Preferred substituted alkyl are mono-, di-, or trisubstituted. The substituents may be lower alkyl, halo, hydroxy, acyloxy (e.g., acetoxy), carboxy, monocyclic heteroaromatic ring, monocyclic carbocyclic aliphatic ring, and monocyclic heterocyclic aliphatic ring.

“Lower alkyl” is an alkyl chain comprised of about 1 to about 3, preferably about 1 to about 2 carbon atoms. Preferred lower alkyl groups include methyl, ethyl, and propyl groups.

“Aromatic ring” is an aromatic hydrocarbon ring. Aromatic rings are monocyclic or fused bicyclic ring systems. Monocyclic aromatic rings contain about 5 to about 10 carbon atoms, preferably about 5 to about 7 carbon atoms, and most preferably about 5 to about 6 carbon atoms in the ring. Bicyclic aromatic rings contain from about 8 to about 12 carbon atoms, preferably about 9 to about 10 carbon atoms in the ring system. Bicyclic aromatic rings include ring systems wherein only one ring in the system is aromatic. Preferred bicyclic aromatic rings are ring systems wherein only one ring in the system is aromatic. Aromatic rings may be unsubstituted or substituted with about 1 to about 4 substituents on the ring. The substituents may be halo, cyano, alkyl, heteroalkyl, haloalkyl, phenyl, phenoxy or any combination thereof. Preferred substituents include halo and haloalkyl. Preferred aromatic rings include furan, thiofuran and phenyl. The most preferred aromatic ring is furan.

“Carbocyclic aliphatic ring” is a saturated or unsaturated hydrocarbon ring. Carbocyclic aliphatic rings are not aromatic. Carbocyclic aliphatic rings are monocyclic. Carbocyclic aliphatic rings contain about 4 to about 10 carbon atoms, preferably about 4 to about 7 carbon atoms, and most preferably about 5 to about 6 carbon atoms in the ring. Carbocyclic aliphatic rings may be unsubstituted or substituted with about 1 to about 4 substituents on the ring. The substituents may be halo, cyano, alkyl, heteroalkyl, haloalkyl, phenyl, phenoxy or any combination thereof. Preferred substituents include halo and haloalkyl. Preferred carbocyclic aliphatic rings include cyclopentyl, cyclohexyl, cyclohexenyl, cycloheptyl, and cyclooctyl. More preferred carbocyclic aliphatic rings include cyclohexyl, cycloheptyl, and cyclooctyl.

“Halo” is fluoro, chloro, bromo or iodo. Preferred halo are fluoro, chloro and bromo; more preferred are chloro and fluoro, most preferred is fluoro.

“Haloalkyl” is a straight, branched, or cyclic hydrocarbon substituted with one or more halo substituents. Preferred haloalkyl are C₁-C₆; more preferred are C₁-C₄; more preferred still are C₁-C₃. Preferred halo substituents are fluoro and chloro. The most preferred haloalkyl is trifluoromethyl.

“Heteroalkyl” is a saturated or unsaturated chain containing carbon and at least one heteroatom, wherein no two heteroatoms are adjacent. Heteroalkyl chains contain about 1 to about 6 member atoms (carbon and heteroatoms) in the chain, preferably about 1 to about 4, more preferably about 1 to about 2. Heteroalkyl chains may be straight or branched. Preferred branched heteroalkyl have one or two branches, preferably one branch. Preferred heteroalkyl are saturated. Unsaturated heteroalkyl have one or more double bonds, one or more triple bonds, or both. Preferred unsaturated heteroalkyl have one or two double bonds or one triple bond, more preferably one double bond. Heteroalkyl chains may be unsubstituted or substituted with about 1 to about 4 substituents. Preferred substituted heteroalkyl are mono-, di-, or trisubstituted. The substituents may be lower alkyl, halo, hydroxy, acyloxy (e.g., acetoxy), carboxy, monocyclic heteroaromatic ring, monocyclic carbocyclic aliphatic ring, monocyclic heterocyclic aliphatic ring, and amino.

“Lower heteroalkyl” is a heteroalkyl chain comprised of about 1 to about 3, preferably about 1 to about 2 member atoms.

“Heteroaromatic ring” is an aromatic ring containing carbon and about 1 to about 4 heteroatoms in the ring. Heteroaromatic rings are monocyclic or fused bicyclic ring systems. Monocyclic heteroaromatic rings contain about 5 to about 10 member atoms (carbon and heteroatoms), preferably about 5 to about 7, and most preferably about 5 to about 6 in the ring. Bicyclic heteroaromatic rings include ring systems wherein only one ring in the system is aromatic. Preferred bicyclic heteroaromatic rings are ring systems wherein only one ring in the system is aromatic. Bicyclic heteroaromatic rings contain about 8 to about 12 member atoms, preferably about 9 to about 10 in the ring. Heteroaromatic rings may be unsubstituted or substituted with about 1 to about 4 substituents on the ring. The substituents may be halo, cyano, alkyl, heteroalkyl, haloalkyl, phenyl, phenoxy or any combination thereof. Preferred substituents include halo, and haloalkyl. Preferred monocyclic heteroaromatic rings include thienyl, thiazolo, and furanyl. More preferred monocyclic heteroaromatic rings include thienyl, and furanyl. The most preferred monocyclic heteroaromatic ring is furanyl. Preferred bicyclic heteroaromatic rings include 9-oxabicyclo[4.3.0]nonyl, 9-thiabicyclo[4.3.0]nonyl, 9-azabicyclo[4.3.0]nonyl, 2-oxabicyclo[3.3.0]octyl, 2-oxabicyclo[2.2.2]octyl, 2-thiabicyclo[3.3.0]octyl, 2-azabicyclo[3.3.0]octyl, 7-oxabicyclo[4.1.0]heptyl, 7-oxabicyclo[2.2.1]heptyl, tetrahydrobenzo[B]thiophenyl, tetrahydroquinolinyl, tetrahydroquinoxalinyl, tetrahydrobenzo[B]furanyl, tetrahydro-benzimidizolyl, tetrahydrobenzoxazolyl, tetrahydroindolyl. More preferred bicyclic heteroaromatic rings include 9-oxabicyclo[4.3.0]nonyl, 9-thiabicyclo[4.3.0]nonyl, 9-azabicyclo[4.3.0]nonyl, and tetrahydro-benzoxazolyl.

“Heteroatom” is a nitrogen, sulfur, or oxygen atom. Groups containing more than one heteroatom may contain different heteroatoms.

“Heteroatom group” is a group that contains a heteroatom, and, if the valence of the heteroatom is not satisfied by the formula, additional hydrogen atoms, lower alkyl groups, or combinations thereof are bonded to the heteroatom to meet the valency requirement of the heteroatom.

“Heterocyclic aliphatic ring” is a saturated or unsaturated ring containing carbon and about 1 to about 4 heteroatoms in the ring, wherein no two heteroatoms are adjacent in the ring and no carbon in the ring that has a heteroatom attached to it also has a hydroxyl, amino, or thiol group attached to it. Heterocyclic aliphatic rings may have aromatic rings attached to them. Heterocyclic aliphatic rings are monocyclic or bicyclic. Heterocyclic aliphatic rings contain about 4 to about 20 member atoms (carbon and heteroatoms), preferably about 4 to about 20 member atoms, and most preferably about 5 to about 6 member atoms in the ring. Heterocyclic aliphatic rings may be unsubstituted or substituted with about 1 to about 4 substituents on the ring. The substituents may be halo, cyano, alkyl, heteroalkyl, haloalkyl, phenyl, phenoxy or any combination thereof. Preferred substituents include halo and haloalkyl. Preferred heterocyclic aliphatic rings include piperzyl, morpholinyl, tetrahydrofuranyl, tetrahydropyranyl and piperdyl. Preferred bicyclic heterocyclic rings include 9-oxabicyclo[4.3.0]nonyl, 9-thiabicyclo[4.3.0]nonyl, 9-azabicyclo[4.3.0]nonyl, 2-oxabicyclo[3.3.0]octyl, 2-oxabicyclo[2.2.2]octyl, 2-thiabicyclo[3.3.0]octyl, 2-azabicyclo[3.3.0]octyl, 7-oxabicyclo[4.1.0]heptyl, 7-oxabicyclo[2.2.1]heptyl.

“Insect” means an animal classified in Phylum Arthropoda. Insect includes animals classified in Class Insecta and Class Arachnida. Insect includes crawling insects such as cockroaches, ticks, mites, lice and spiders. Insect also includes flying insects such as mosquitoes, houseflies, wasps, hornets and yellow jackets. Insect also includes hopping insects such as fleas.

“Phenyl” is a monocyclic aromatic ring which may or may not be substituted with about 1 to about 4 substituents. The substituents may be fused but not bridged and may be substituted at the ortho, meta or para position on the phenyl ring, or any combination thereof. The substituents may be halo, acyl, cyano, alkyl, heteroalkyl, haloalkyl, phenyl, phenoxy or any combination thereof. Preferred substituents on the phenyl ring include halo and haloalkyl. The most preferred substituent is halo.

This invention relates to compounds, compositions, and methods for killing insects. The compounds and compositions can kill insects on contact and can produce a vapor that kills in minutes when the compound or composition is applied in cracks and crevices, behind walls and obstacles without application to the insect needed.

Compounds

In one embodiment of the invention, the compound is a bicyclic heterocyclic compound (heterobicyclic compound) having at least 7 carbons and at most 20 carbons with at least one heteroatom in one of the rings. The heterobicyclic compound has vapor phase insecticidal activity. One skilled in the art would be able to identify compounds having vapor phase insecticidal activity without undue experimentation by, for example, using the method described in Reference Example 1, below. Preferred compounds have a vapor phase insecticidal activity as tested by the method in Reference Example 1 of less than 100 milligrams/500 milliliters. More preferred compounds have a vapor phase insecticidal activity of about 10 micrograms/500 milliliters to about 50 milligrams/500 milliliters.

Preferred heterobicycles include 9-oxabicyclo[4.3.0]nonyl, 9-thiabicyclo[4.3.0]nonyl, 9-azabicyclo[4.3.0]nonyl, 2-oxabicyclo[3.3.0]octyl, 2-oxabicyclo[2.2.2]octyl, 2-thiabicyclo[3.3.0]octyl, 2-azabicyclo[3.3.0]octyl, 7-oxabicyclo[4.1.0]heptyl, and 7-oxabicyclo[2.2.1]heptyl rings.

Examples of bicyclic heterocyclic compounds that have vapor phase insecticidal activity include, but are not limited to, 7-oxabicyclo[4.1.0]heptane compounds such as limonene oxide and isolimonene oxide; 2-oxabicyclo[2.2.2]octane compounds such as the 1,8 cineoles, 7-oxabicyclo[2.2.1]heptane analogs such as the 1,4 cineoles.

One particularly preferred series of bicyclic heterocyclic compounds comprises 9-heterobicyclo [4.3.0]analogs having the formula: 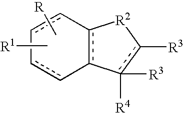
wherein each R is independently selected from the group consisting of a hydrogen atom, a haloalkyl group, and a lower alkyl group. Preferably, each R is independently selected from the group consisting of a hydrogen atom and a lower alkyl group.

R¹ is selected from the group consisting of a hydrogen atom, a haloalkyl group, and a heteroatom group. Preferred heteroatom groups for R¹ include hydroxyl.

R² is a heteroatom, preferably selected from the group consisting of oxygen, nitrogen, and sulfur. More preferably, R² is oxygen.

Each R³ is independently selected from the group consisting of a hydrogen atom, a lower alkyl group, and a haloalkyl group.

R⁴ is selected from the group consisting of a hydrogen atom, a heteroatom group, and a haloalkyl group. R⁴ is preferably selected from the group consisting of a hydrogen atom and a heteroatom group. Preferred heteroatom groups for R⁴ include hydroxyl.

In an alternative preferred embodiment of the invention, the heterobicyclic compound has the formula: 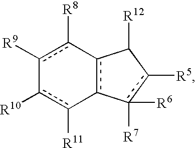
wherein R⁵ is selected from the group consisting of a hydrogen atom, a lower alkyl group, and a haloalkyl group. R⁵ is preferably selected from the group consisting of a hydrogen atom and a lower alkyl group.

R⁶ is selected from the group consisting of a hydrogen atom, a lower alkyl group, and a haloalkyl group. R⁶ is preferably selected from the group consisting of a hydrogen atom and a lower alkyl group.

R⁷ is selected from the group consisting of a hydrogen atom, a heteroatom group, a lower alkyl group, and a haloalkyl group. R⁷ is preferably selected from the group consisting of a hydrogen atom and a heteroatom group. Preferred heteroatom groups for R⁷ include hydroxyl.

R⁸, R⁹, R¹⁰, and R¹¹, are each independently selected from the group consisting of halo, a hydrogen atom, a heteroatom group, a haloalkyl group, and a lower alkyl group. Preferred heteroatom groups include hydroxyl. Preferred lower alkyl groups include ethyl and propyl.

R¹² is selected from the group consisting of a hydrogen atom and a lower alkyl group. When R¹² is a hydrogen atom, both rings are saturated, and R⁸, R¹⁰, and R¹¹ are all hydrogen atoms, then either R⁶ and R⁷ are both not methyl groups or R⁹ is not a methyl group.

In an alternative preferred embodiment of the invention, the heterobicyclic compound has the formula: 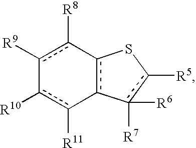
wherein R⁵, R⁶, R⁷, R⁸, R⁹, R¹⁰, and R¹¹ are as described above, with the proviso that when R⁸, R¹⁰, and R¹¹ are hydrogen atoms, then either R⁶ and R⁷ are both not methyl groups or R⁹ is not a methyl group.

In an alternative preferred embodiment of the invention, the heterobicyclic compound has the formula: 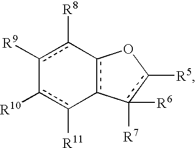
wherein R⁵, R⁶, R⁷, R⁸, R⁹, R¹⁰, and R¹¹ are as described above, with the provisos that:
when R⁶, R⁷, and R⁹ are all hydrogen atoms, then at least one of R⁸, R¹⁰, and R¹¹ is selected from the group consisting of halo, a haloalkyl group, and a heteroatom group;
when R⁷ is a hydrogen atom and R⁶ and R⁹ are both methyl groups, then at least one of R⁸, R¹⁰, and R¹¹ is selected from the group consisting of halo, a haloalkyl group, and a heteroatom group; and
when R⁶ is a hydrogen atom and R⁷ and R⁹ are both methyl groups, then at least one of R⁸, R¹⁰, and R¹¹ is selected from the group consisting of halo, a haloalkyl group, and a heteroatom group. Preferred heteroatom groups include hydroxyl.

Nonlimiting examples of suitable heterobicyclic compounds are shown below in Table 1.

TABLE 1
HETEROBICYCLIC COMPOUNDS

| | | |
|---|---|---|
| 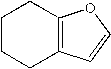 | 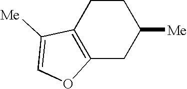 | 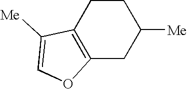 |
| 4,5,6,7 tetrahydro oxaindene | (+) menthofuran | (+/−) menthofuran |
| 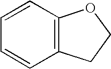 | 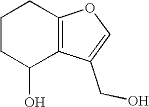 | 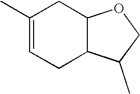 |
| 2,3-dihydro benzol[b]furan | 3-(hydroxymethyl)-4,5,6,7- tetrahydrooxainden-4-ol | 3,7-dimethyl-9- oxabicyclo[4.3.0]non-3-ene |
| 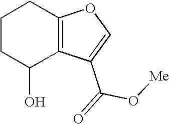 | 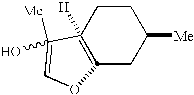 | 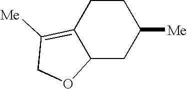 |
| methyl5-hydroxy-9- oxabicyclo[4.3.0]nona- 1,(6),7-diene-7-carboxylate | | 4,9-dimethyl-7- oxabicyclo[4.3.0]non-1(9)-ene |
| 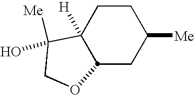 | 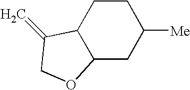 | 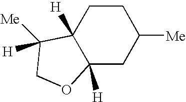 |
| 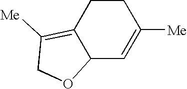 | 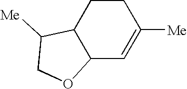 | 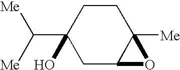 |
| linden ether | anethofuran | exo-epoxy-terpinede-4-ol |
| 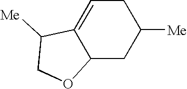 | 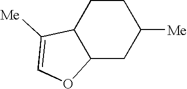 | 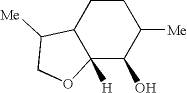 |
| 3,7-dimethyl-9- oxabicyclo[4.3.0]non-5-ene | 3,7-dimethyl-9- oxabicyclo[4.3.0]non-7-ene | 2-hydroxy-3,7-dimethyl-9- oxabicyclo[4.3.0]nonane |
| 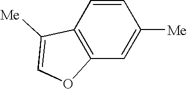 | 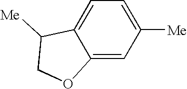 | 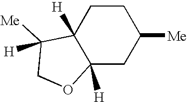 |
| 3,6 dimethyl benzo[b]furan | 3,6 dimethyl, 2,3-dihydro benzo[b]furan | tetrahydromenthafuran |
| 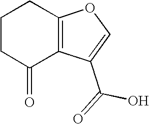 | 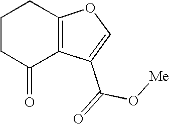 | 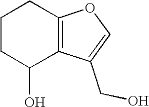 |
| 5-oxo-9-oxabicyclo [4.3.0]nona-1-,(6),7-diene-7- carboxylic acid | methyl 5-oxo-9- oxabicyclo[4.3.0] nona-1,(6),7- carboxylate | 3-(hydroxymethyl)-4,5,6,7- tetrahydrooxainden-4-ol |
| 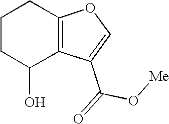 | 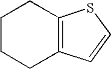 | 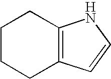 |
| methyl5-hydroxy-9- oxabicyclo[4.3.0] nona 1,(6),7-diene-7-carboxylate | 4,5,6,7 tetrahydro thiaindene | 4,5,6,7 tetrahydro thiaindene |
| 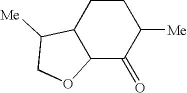 | 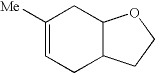 | 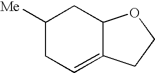 |
| 3,7-dimethyl-9- oxabicyclo[4.3.0]non-2-one | 4-methyl-7-4 oxabicyclo[4.3.0]non-3-ene | 4-methyl-7- oxabicyclo[4.3.0]non-1(2)-ene |
| 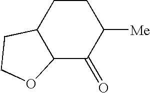 | 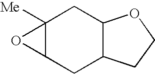 | 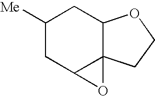 |
| 3-methyl-9 oxabicyclo[4.3.0]nonan-2-one | 4-methyl-7- oxabicyclo[4.3.0]non-3-ene epoxide | 4-methyl-7- oxabicyclo[4.3.0]non-1(2)-ene epoxide |
| 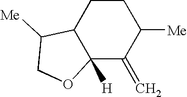 | 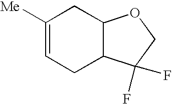 | 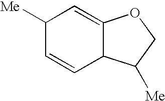 |
| 2-methylenyl-3,7-dimethyl-9- oxabicyclol[4.3.0]nonane | 9,9-difluoro-4-methyl-7-4 oxabicyclol[4.3.0]non-3-ene | 4-methyl-7- oxabicyclo[4.3.0]non-1(6),3- diene |
| 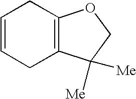 | 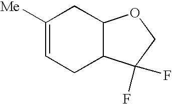 | 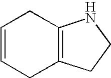 |
| 4-methyl-7- oxabicyclo[4.3.0]non-1(6),3- diene | 2,3,4,7 tetrahydro thiaindene | 2,3,4,7 tetrahydro thiaindene |

‘Me’ represents a methyl group.

Some (9-heterobicyclo[4.3.0]) analogs are known in the art and commercially available. Some (9-heterobicyclo[4.3.0]) analogs can be isolated from natural products by methods known in the art. For example, 3,6-dimethyl-3a,4,5,7a-tetrahydrocoumaran (CAS No. 65627-88-5) and 3,6-dimethylcoumaran (CAS No. 65627-89-6) can be isolated from dill essential oil. (See Belafi-Rethy, K.; Kerenyi, E., “Study of the composition of indigenous and foreign essential oils, VI. Coumaran derivatives in dill plant essential oil,” Hung. Pet. Res. Inst., Veszprem, Hung. Acta Chim. Acad. Sci. Hung. (1977), 94(1), 1-9.) Others can be synthesized by those of ordinary skill in the art. For example, the epoxides are obtained from the alkenes by the process of epoxidation using any of the many epoxidizing agents and conditions such as meta-chloroperoxybenzoic acid in methylene chloride. A few illustrative, non-limiting examples are shown below.

In an alternative embodiment of the invention, the compound is a low molecular weight ester having the formula: 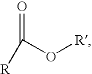
wherein R is as described above and R′ is selected from the group consisting of a hydrogen atom, an alkyl group, and a cycloalkyl group.

In an alternative embodiment of the invention, the compound is a low molecular weight diester having the formula: 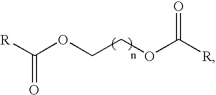
wherein R is as described above and n is about 1 to about 4.

Examples of suitable esters and diesters are shown below in Table 2.

TABLE 2
ESTERS AND DIESTERS

| | |
|---|---|
| 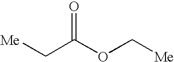 | 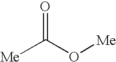 |
| methyl propionate | methyl acetate |
| 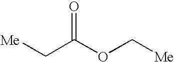 | 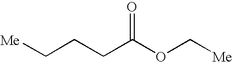 |
| ethyl propionate | ethyl valerate |
| 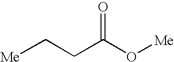 | 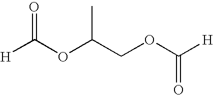 |
| methyl butyrate | 1,2 propylene glycol diformate |
| 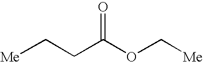 | 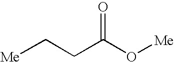 |
| ethyl butyrate | ethylene glycol diformate |
| 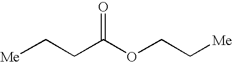 | 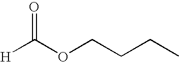 |
| propyl butyrate | butyl formate |
| 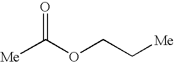 | 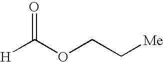 |
| n-propyl acetate | propyl formate |
| 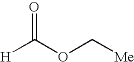 | 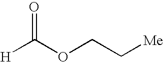 |
| ethyl formate | butyl propionate |
| 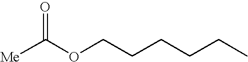 | 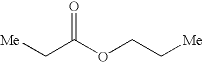 |
| hexyl acetate | propyl propionate |
| 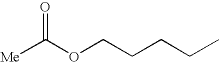 | 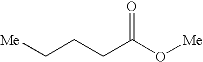 |
| pentyl acetate | methyl valerate |
| 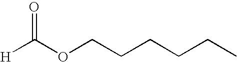 | 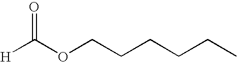 |
| hexyl formate | heptyl formate |
| 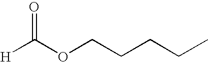 | 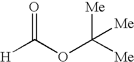 |
| pentyl formate | tert-butyl formate |
| 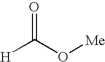 | 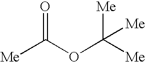 |
| methyl formate | tert-butyl acetate |
| 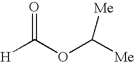 | 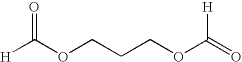 |
| iso-propyl acetate | 1,3-propylene glycol diformate |
| 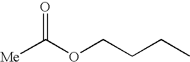 | 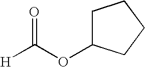 |
| n-butyl acetate | cyclopentyl formate |
| 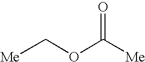 | 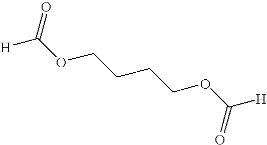 |
| ethyl acetate | 1,4-propylene glycol diformate |

‘Me’ represents a methyl group.

Some of the esters are known in the art and commercially available. Alternatively, the esters may be synthesized as described below.

The invention also includes optical isomers, diastereomers and enantiomers of the named structures. Thus, at all stereocenters where stereochemistry is not explicitly defined, all possible epimers are envisioned. Preferred stereochemistry at all such stereocenters of the compounds of the invention mimic that of naturally occurring compounds, although where tested epimers of active compounds have been tested, all have had at least some measurable activity in the assay.

In an alternative embodiment of the invention, the compound is a combination of two or more of the above compounds.

Compositions

All of the compounds described above have vapor phase insecticidal activity, and may be combined with each other in all proportions. However, with the (9-heterobicyclo[4.3.0]) analogs and monoesters it is preferable to add alcohol, such as ethyl alcohol, isopropyl alcohol, and others, to prevent the composition from potentially discoloring plastic.

Typically, the composition comprises about 0 to about 50%, preferably about 0.1 to about 50%, more preferably about 1 to about 2% of the bicyclic heterocyclic compound described above. The balance may be an ester, as described above, or a combination of the ester and the alcohol, or an ester or alcohol in combination with one or more other optional ingredients.

Other optional ingredients include the oils and extracts and steam distillates of the natural products containing the compounds described above, when the compound chosen is found in a natural product. These oils and natural sources include, but are not limited to, linden honey, lime blossoms (Tilia cordada), dill leaves, essential oil of dill, tea tree oil, peppermint leaves, oil of peppermint, oil of G. cordifolium, lemon, lime, orange (both blood and blond), or other mint or citrus oils or extracts, lemon grass oil, sage oil, and oil of cedar. Another source is the volatiles of the Longan fruit, the papaya fruit, yellow passion fruit, and the tea made from the leaves of E. ulmoides, C. nepeta, and various peppermint sps and species such as Calamintha ashei.

Optional ingredients include other natural products, either essential oils and extracts or steam distillates, or racemates of the compounds described above made by synthetic processes. Some optional ingredients have contact insecticidal activity, and some optional ingredients were found to have vapor phase insecticidal activity, however, not all optional ingredients having contact insecticidal activity also have vapor phase insecticidal activity. Without wishing to be bound by theory, it is thought that the more volatile optional ingredients are more likely to have vapor phase activity than the less volatile ones.

Other optional ingredients include other actives having contact insecticidal activity (contact actives) with insufficient vapor phase insecticidal activity to be used as the active compound in the composition. While these would not have vapor phase insecticidal activity, they would provide, if desired, a contact-vapor phase combination activity, when both types of activity are desired. Examples of contact actives suitable to use as optional ingredients in the compositions of this invention include, but are not limited to eugenol, isoeugenol, trans cinnamaldehyde, trans, trans farnesol, RAID®—crawling insect killer, vanillin, perillyl alcohol (mix of isomers), (+) Terpinen-4-ol; D,L-menthol (racemic), (−) alpha-Terpineol, Dimethyl sulfoxide, bicyclo[4.1.0]heptane-7-carboxylic acid, dihydrocarveol (mix of isomers), isolongifolene, (+) isomenthol, (+) isopinocampheol, (+) trans myrtanol, (−) myrtenal, and combinations thereof.

Furthermore, traditional carriers such as petroleum distillates, could be used instead of alcohols and esters when the active compound is a bicyclic heterocyclic compound described above. Another series of carriers are the biodegradable oils, including the Olestra™ family of oils.

When the composition will be used as an aerosol, it is preferable to add a propellant. Suitable propellants include propane, butane, isobutane, dimethyl ether, carbon dioxide, nitrous oxide, nitrogen, and combinations thereof.

The compositions described above can be prepared by any convenient means, e.g., by mixing the active compound or active compounds with one or more other ingredients described above.

Methods of Use

The compounds and compositions of the present invention are useful in ridding buildings of unwanted insects, preferably without persisting in the environment. The compounds and compositions may be applied as an oil or as a spray, e.g., in a pump-spray bottle, or in an aerosol can.

Preferred routes of administration for the contact kill of crawling insects, include applying the compounds and compositions as an oil, from a pump-spray bottle, or from an aerosol can. The dosage range for the active compounds of this invention is about 0.1 gram to about 10 grams per insect, preferably about 0.5 to about 5 grams per insect. The dosages will be designed to knock down the insect and allow it to be either physically crushed, or vulnerable to a further spray. The compounds and compositions also kill more than 99% of the germs on the insect and in the area of application when applied as a spray.

In an alternative embodiment of the invention, preferred routes of administration for the vapor phase kill of crawling insects include applying the active compounds and compositions to a surface as an oil or spray. For example, the active compound or composition can be applied to surfaces, including cracks and crevices, absorbent surfaces, and non-absorbent surfaces. In this embodiment of the invention, the dosage range for the active compounds is about 0.1 gram to about 10 grams per cubic foot of airspace. The compounds and compositions are sprayed directly into the cracks, crevices, behind drawers, in corners, and spaces behind furniture, appliances and the like. Direct contact is not necessary as the killing can be done in the vapor phase. The amount will be designed to knock down the insect and allow it to be immobilized where a higher concentration of the vapor will prove toxic. The active compound or composition may be applied as often as about 4 times per day in the affected areas but preferably not less than about once per day until the infestation is eradicated. The compounds and compositions also kill more than 99% of the germs in the area of application when applied as a spray in this embodiment of the invention.

In an alternative embodiment of the invention, the compounds and compositions can be used for the destruction of nests of crawling or flying insects. In this embodiment, the compounds and compositions are applied as oils or sprays, e.g., from a pump-spray bottle, or an aerosol can. The dosage range for the active compounds in this embodiment of the invention is about 0.1 gram to about 100 grams per nest. The compounds and compositions are sprayed from a safe distance to saturate the outer surface of the nest. Direct contact with the insects is not necessary as the killing can be done in the vapor phase. The amount is designed to knock down the insect within the nest, where the continual presence of the vapors will prove toxic. The compounds and compositions will also kill eggs in the nest. The compounds and compositions also kill more than 99% of the germs in the area of application when applied as a spray in this embodiment of the invention.

In an alternative embodiment of the invention, the compounds and compositions can be used for the contact kill of flying, biting or stinging insects. In this embodiment, the compounds and compositions are applied as oils or sprays, e.g., from a pump-spray bottle or an aerosol can. The dosage range for the active compounds in this embodiment of the invention is about 0.1 gram to about 5 grams per insect. The compounds and compositions are sprayed from a safe distance onto the surface of the insect. The insect should be knocked down before a closer approach or the crushing of an insect should occur. Some stinging insects can still sting even after death, so caution is advised. The compounds and compositions also kill more than 99% of the germs in the area of application when applied as a spray in this embodiment of the invention.

Methods for Determining Vapor Phase Insecticidal Activity

This invention further relates to methods for determining vapor phase insecticidal activity. The method generally comprises: 1) adding a composition to be tested for vapor phase insecticidal activity to a container, wherein the container contains at least one insect, and wherein the container is configured such that the insect is not forced to contact the composition in any form other than vapor phase of the composition (i.e., no direct contact), and wherein the container is configured such that the composition cannot escape the container during the method.

Step 1) can be carried out by, for example, adding a composition to be tested for vapor phase insecticidal activity to a carrier, wherein the carrier is contained in a container with at least one insect, and wherein the carrier is configured such that the insect is not forced to contact the carrier, and closing the container.

The composition in step 1) may be a single component, or the composition may comprise more than one component. Typically, more than one insect is added to the container, typically at least about 5 to about 6 insects. The composition may be tested for vapor phase insecticidal activity on any insect according to this method, however, the method is particularly well suited for testing crawling insects such as cockroaches and spiders.

The container may be any conventional container that will contain a sufficient amount of air such that the insect will not suffocate due to lack of oxygen when the container is closed for the duration of the method. The container is sufficiently airtight when closed that the composition to be tested does not escape from the container during the duration of the method. The container can be, for example, a glass jar with a lid. The container typically has a capacity of about 500 milliliters to about 2 liters. The container may have one or more compartments separated by a vapor permeable barrier, e.g., one compartment in which the insect is located and a second compartment in which the composition is located.

The carrier can be any conventional carrier configured such that the composition to be tested leaves the carrier in its vapor phase. Preferably the carrier is configured such that the composition does not leave the container in liquid or solid form, i.e., the carrier is configured to contain the composition such that the composition does not contact kill the insect; insect is exposed to the composition only in its vapor phase. The carrier can be, for example, an absorbent material such as woven or nonwoven paper or fabric.

The method may further comprise: 2) monitoring the insect after step 1) to classify condition of the insect. The insect may be monitored by any conventional means, such as visually. The insect may be monitored periodically at any convenient time intervals, such as about 1 minute, about 15 minutes, about 30 minutes, about 45 minutes, about 1 hour, about 2 hours, or about 4 hours, or combinations thereof. The duration of the method is typically about 15 minutes to about 24 hours.

Furthermore, when there are at least 2 insects in the container, the method may further comprise: 3) determining an LD₅₀ for the composition based on amount of the composition required for 50% mortality at a specified time, e.g., at 4 and 24 hours. LD₅₀ can be determined, for example, based on the amount of the composition required for 50% mortality at 4 and 24 hours. This can be done by taking multiple tests and plotting them on a dose-response curve such as the GraphPad® Prism® computer program. This program interpolates to find the midpoint of any sigmoidal dose-response curve.

An example of this method is described below in Reference Example 1.

### EXAMPLES

These examples are intended to illustrate the invention to one skilled in the art and should not be interpreted as limiting the scope of the invention set forth in the claims.

### Reference Example 1

### Vapor Phase Assay

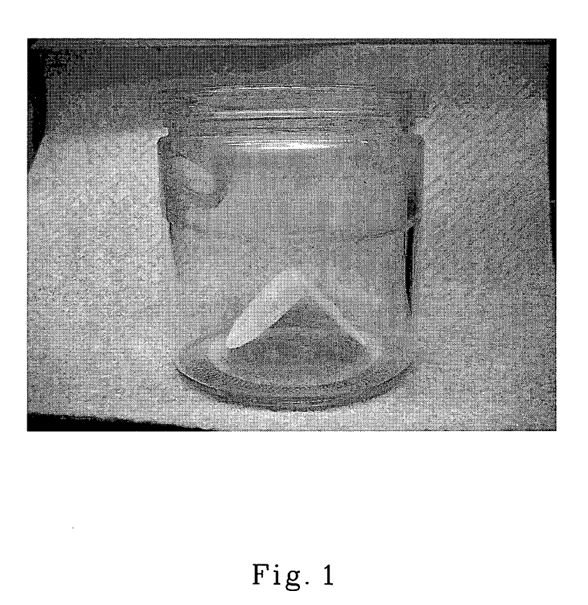

The device for this assay is shown in FIG. 1. An ˜500 mL jar is coated at the top with a thin film of petroleum jelly and covered with a plastic petri dish as a lid. Five roaches and one sheet of #4 Whatman® 15 centimeter diameter filter paper are added to the container. The filter paper is bent in half to form a ‘tent’, as shown, so the roaches are not forced to contact the filter paper. The lid is removed, and a compound or composition to be tested is added to the top of the paper, at the bend. The lid is replaced and the insects monitored for activity at 15, 30, 45 minutes, then 1, 2, 4 and 24 hours post exposure. The insects are classified as either “normal”, “distressed” (usually this means they are on their back) or “dead” (which is defined as no movement for >7 sec, or no movement after shaking or prodding. Note: Some insects recover from the effects of chemicals with time, so the 24 hour percent dead does not always match the 4 hour ‘dead’.).

An “LD₅₀” is determined for the compound or composition based on the amount of active compound or composition required for 50% mortality at 4 and 24 hours. This is done by taking multiple testes and plotting them on a dose-response curve such as the GraphPad® Prism® computer program. This program interpolates to find the midpoint of any sigmoidal dose-response curve.

### Example 1

### Menthofuran

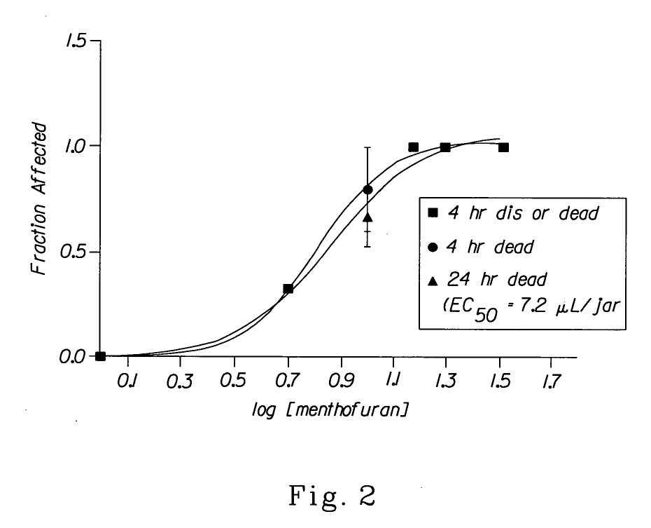

Menthofuran is tested according to the method of Reference Example 1. The raw data for (+)-menthofuran (1), and a typical dose response curve are found in Table 1 and in FIG. 2, respectively. The LD₅₀ of menthofuran is calculated to be 7.2 microliters/500 milliliters headspace.

TABLE 1
Vapor-phase Raw Data for (+)-Menthofuran

| 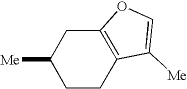 | | | |
|---|---|---|---|
| | Percent | | |
| | Distressed | Percent Dead | |
| .() menthofuran; | or Dead | Only | Percent Dead |
| (1) | at 4 hours | at 4 hours | at 24 hours |
| 33 □L | 100% | 100% | 100% |
| 20 □L | 100% | 100% | 100% |
| 15 □L | 100% | 100% | 100% |
| 10 □L | 100% | 100% | 80% |
| 5 □L | 33%* | 33%* | 33%* |
| 10 □L (repeat) | 40% | 40% | 40% |

*= 6 insects were used in this jar.

The data in Table 1 can graphed as a sigmoidal dose response, much the same as any other biological data. This gives a standard dose-response curve as seen in FIG. 2. The mid-Point of the dose-response curve is given by the computer and used to compare potencies. There are relative potencies only, and small changes in the design of the apparatus can significantly affect the results. It is also necessary to understand the range of the testing. While the lower limit is in the 1 to 3 microliter range, the upper limit is about 250 microliters. Adding more material than that to the filter paper will allow the substance to drip onto the glass, where contact with the insects might occur. Another caveat one must keep in mind is that, when the volume of the jar is changed, the results are non-linear. Several compounds are tested in a 2 liter (L) jar rather than the 0.5 L jars which are the primary assay. One might expect the amount of the compound to have tracked the 4-fold volume increase, but in all cases the LD₅₀ in that larger environment only increases by approximately two-fold. Therefore, the LD₅₀'s reported for the 0.5 L jars should only be used as comparative toxicity for that size. The LD₅₀ for menthofuran in a 2 L jar is 15 microliters per 2 L headspace.

### Comparative Example 1

### Vapor Phase Activity of Contact Actives

Various compounds known as contact actives were tested by the method of Reference Example 1. The contact actives and their LD₅₀ values are as follows: eugenol (LD_{50>300} milligrams/500 milliliter); isoeugenol (LD_{50>100} milligrams/500 milliliters), trans cinnamaldehyde (LD_{50>100} milligrams/500 milliliters), and RAID®—crawling insect killer which is commercially available from S. C. Johnson & Son, Inc. of Racine, Wis. (>350 millligrams/500 milliliters). Frequently, the amount of contact active added to the filter paper was so high that it dripped off the paper, and thereby contacted the insects.

Comparative Example 1 shows that contact actives have insufficient vapor phase insecticidal activity for use as the vapor phase active compound in this invention. However, these contact actives may be added to the compositions of this invention as optional ingredients to provide additional contact activity.

### Example 2

### Activity of Esters

Several Esters are Evaluated by the Method of Reference Example 1.

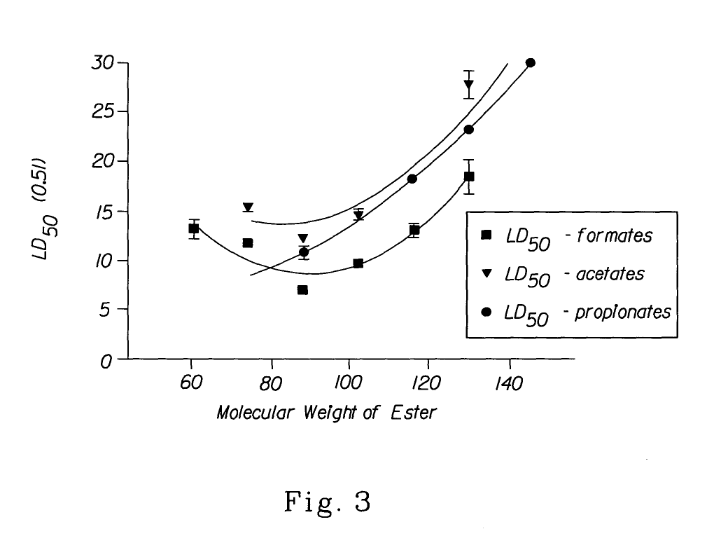

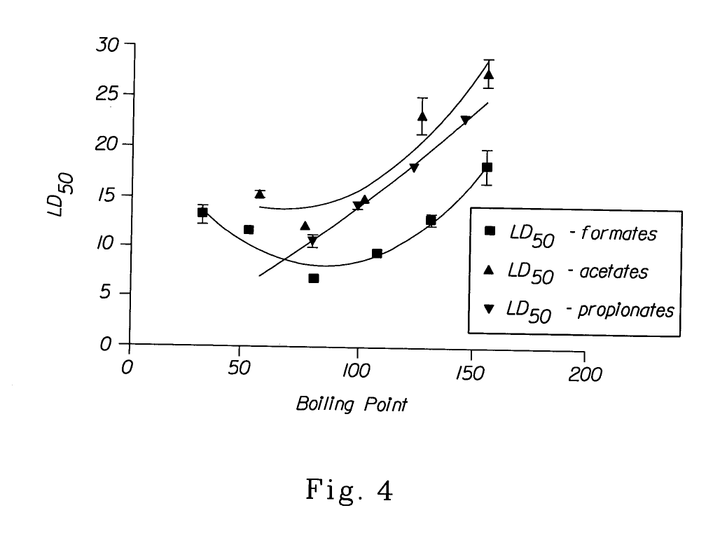

Monoesters: As shown in FIGS. 3 and 4, the activity of the esters seems to be related to their volatility. However, rather than the most volatile compounds (i.e., those with the lowest molecular weight, FIG. 3, or those with the lowest boiling point FIG. 4, there is a distinct dip in the LD₅₀ curves at a molecular weight of ˜90 g/mol, or with a boiling point of 75-90° C.

Cyclic and branched esters: In addition to the n-alkyl esters shown in these figures, the branched-chain and cyclic esters were also investigated, such as tert-butyl (compound 2-1, below) and cyclopentyl formate (compound 2-2, below). These compounds are also active and potent, with 24 hr LD₅₀'s of 40 microliters and 17 microliters per 500 milliliters headspace, respectively.

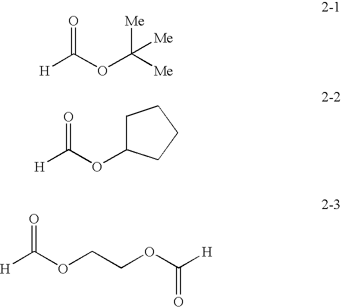

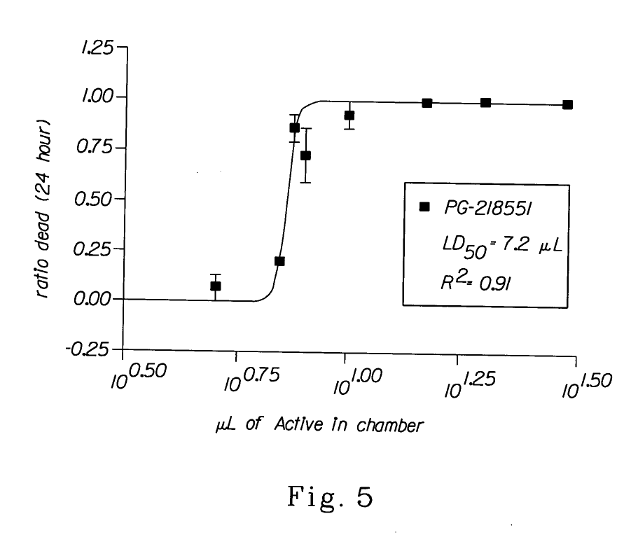

Diformate Esters: The activity of diformate esters is also investigated. Shown here is the most potent compound of the series, ethylene glycol diformate (EGDF, compound 2-3). The LD₅₀ curve for this compound is shown in FIG. 5. While the diformates in general have a higher molecular weight than the monoformates, they are still potent compounds. The molecular weight of EGDF is 118 grams/mole.

The compound EGDF and its congeners, in contrast to the monoformates, acetates, and propionates, does not act as an organic solvent, and thus does not mar or etch plastic surfaces. (However, the phenomenon of etching plastic is manageable by dilution with ethanol in the case of the propyl and butyl monoformates or by careful application in all cases.)

### Example 3

### Vapor Phase Activity of Mixtures

Two compounds in particular, (R) (−) carvone, work better when combined than when individually tested. (When individually tested at 29 milligrams/500 milliliters only ⅕ of the roaches die in 24 hrs) and (1R) (−) fenchone, which, when combined with (+) cis limonene oxide gives an LD₅₀ of approximately 10 milligrams/500 milliliters). Example 3 shows that some compounds unsuitable to use alone as the active compound for vapor phase insecticidal activity may be suitable when combined with another compound.

### Reference Example 3

### Synthesis of Formate Esters and Diesters

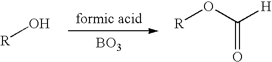 Scheme 1 General Synthesis of Monoformates from Alcohols

As shown in Scheme 1, one preferred way synthesizing formate esters or diesters is by the reaction of anhydrous formic acid with an alcohol in the presence of BO₃. Anhydrous formic acid, boron oxide, and p-toluenesulfonic acid are combined in a suitable solvent such as in methylene chloride. The mixture is refluxed with vigorous stirring. After approximately 1 hour, the reaction mixture is chilled in ice water and filtered. The filtrate is treated with anhydrous potassium carbonate, re-filtered, and stirred for 1 hour with phosphorus pentoxide. The mixture is decanted and then distilled.

### Reference Example 4

### Synthesis of Esters from Alcohols

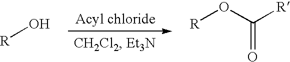 Scheme 2 General Synthesis of Other Esters from Alcohols

When the acid is an organic acid other than formic acid, there are many ways to create a ester that are well-known to one of ordinary skill in the art. The most general methods are Fischer esterification and the reaction of an acid chloride with the alcohol in the presence of a suitable base, such as triethylamine.

### Reference Example 5

### Analysis of Synthesized Compounds

All synthesized compounds were analyzed using ¹H and ¹³C NMR, Elemental analysis, mass spectra, high resolution mass spectra and/or IR spectra were taken as appropriate. Typically, inert solvents were used, preferably in anhydrous form. For example, tetrahydrofuran (THF) was, when necessary, distilled from sodium and benzophenone, diisopropylamine was when necessary, distilled from calcium hydride; all other solvents are purchased as the appropriate grade. Chromatography was performed on silica gel (70-230 mesh; Aldrich) or (230-400 mesh; Merck) as appropriate. Thin layer chromatography (TLC) analysis was performed on glass mounted silica gel plates (200-300 mesh; Baker) and visualized using UV, 5% phosphomolybdic acid in ethanol (EtOH), or ammonium molybdate/ceric sulfate in 10% aqueous H₂SO₄.

### Example 4

### Synthesis of 3,7-dimethyl-9-oxabicyclo[4.3.0]nonan-7-ol (4B and 4C)

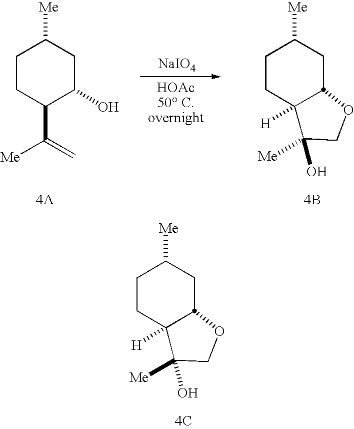

Sodium periodate near saturation is prepared by stirring in H₂O. When the solution is clear, an equal portion of glacial acetic acid (HOAc) is added slowly, with gentle stirring, which is followed by a portion of tetrahydrofuran (THF). The solution should remain clear with no precipitate. A portion of alkene isopulegol, 4A, is added in 10 milliliters of additional THF, and the reaction is heated to 40° C. overnight. The initially clear solution gradually thickens and darkens with a precipitate. When the starting material is consumed as judged by TLC, the stirring is stopped and the THF is removed by rotary evaporation. A portion of ethyl acetate (EtOAc) is added, the solution is filtered under vacuum, and the filtrate washed with water to remove the acetic acid. The combined organic layers are concentrated and flashed giving the cyclized alcohol 4B.

### Example 5

### Synthesis of C₄C₆O₄

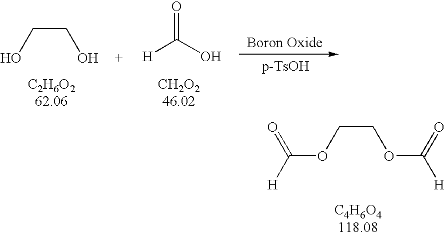

To a 500 milliliter round-bottom flask is added sequentially the glycol, anhydrous formic acid, boron oxide, and p-toluenesulfonic acid in methylene chloride. The mixture is refluxed with vigorous stirring. After 1 hour, the reaction mixture is chilled in ice water and filtered. The filtrate is treated with anhydrous potassium carbonate, re-filtered, and stirred for 1 hour with phosphorus pentoxide to remove any residual alcohol. The mixture is decanted and then distilled at 0.05 Torr to afford the clear colorless diformate.

### Example 6

### Synthesis of C₆H₁₀O₄

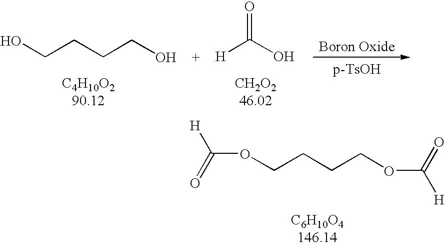

To a 500 milliliter round-bottom flask is added sequentially the glycol, anhydrous formic acid, boron oxide, and catalytic p-toluenesulfonic acid in methylene chloride. The mixture is refluxed with vigorous stirring. After 1 hour, the reaction mixture is chilled in ice water and filtered. The filtrate is treated with anhydrous potassium carbonate, re-filtered, and stirred for 1 hour with phosphorus pentoxide to remove any residual alcohol. The mixture is decanted and then distilled at 0.05 Torr to afford the clear colorless diformate.

### Example 7

### Synthesis of C₅H₈O₄

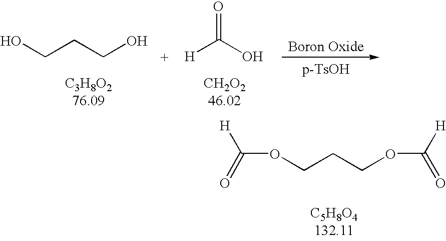

To a 500 milliliter round-bottom flask is added sequentially the glycol, anhydrous formic acid, boron oxide, and p-toluenesulfonic acid in methylene chloride. The mixture is refluxed with vigorous stirring. After 1 hour, the reaction mixture is chilled in ice water and filtered. The filtrate is treated with anhydrous potassium carbonate, re-filtered, and stirred for 1 hour with phosphorus pentoxide to remove any residual alcohol. The mixture is decanted and then distilled at 0.05 Torr to afford the clear colorless diformate

### Example 8

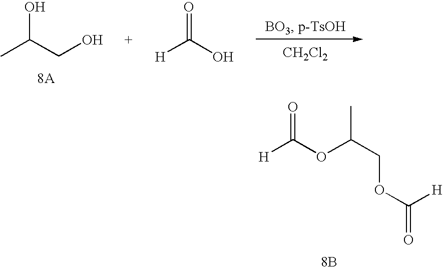

To a 500 milliliter round-bottom flask is added sequentially the glycol 8A, anhydrous formic acid, boron oxide, and p-toluenesulfonic acid in methylene chloride The mixture is refluxed with vigorous stirring. After 1 hour, the reaction mixture is chilled in ice water and filtered. The filtrate is treated with anhydrous potassium carbonate, re-filtered, and stirred for 1 hour with phosphorus pentoxide to remove any residual alcohol. The mixture is decanted and then distilled at 0.05 Torr to afford the clear colorless diformate 8B.

### Example 9

### Synthesis of C₆H₁₀O₂

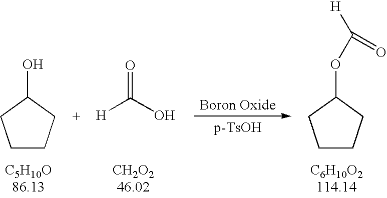

To a 500 milliliter round-bottom flask is added sequentially cyclopentyl alcohol, anhydrous formic acid, boron oxide, and p-toluenesulfonic acid in methylene chloride. The mixture is refluxed with vigorous stirring. After 1 hour, the reaction mixture is chilled in ice water and filtered. The filtrate is treated with anhydrous potassium carbonate, re-filtered, and stirred for 1 hour with phosphorus pentoxide to remove any residual alcohol. The mixture is decanted and then distilled at 0.05 Torr to afford the clear colorless cyclopentyl formate.

### Example 10

### C₁₀H₁₀O₄

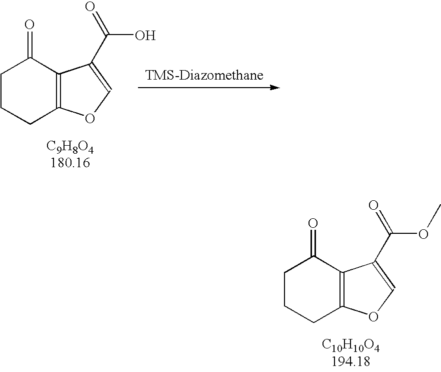

To a 500 milliliter round-bottom flask added 4-oxo-4,5,6,7-tetrahydrobenzo[b]furan-3-carboxylic acid dissolved in 200 milliliters of methanol. 2.0M TMS-diazomethane was dropwise added at 0 degrees. The reaction is allowed to stir overnight at room temperature. The starting material is consumed as determined by TLC analysis. The resulting mixture is concentrated to a brown solid and purified by chromatography using 40% ethyl acetate/hexane as eluent. A brown solid is obtained.

### Example 11

### Synthesis of C₉H₁₂O₃

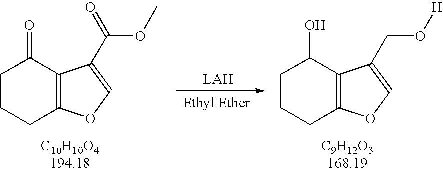

To a 500 milliliter round-bottom flask is added 4-oxo-4,5,6,7-tetrahydrobenzo[b]furan-3-methyl ester and dry diethyl ether (Et₂O). The mixture is cooled to 0 degrees C. in an ice bath and portion-wise is added lithium aluminum hydride (LAH) (0.7 g, 17.9 mmol) over 15 minutes. The reaction is stirred for an additional 30 minutes. Then is added carefully and sequentially 1 portion of water, one portion of 15% NaOH, and then 3 portions water with 10 minutes of stirring in between each addition. (This is the ‘Fieser LAH work-up procedure’, known to one of ordinary skill in the art). Filtering gives a light brown crude material. Purification by column chromatography using 5% methanol (MeOH) in CH₂Cl₂ gives a light brown oil.

### Example 12

### Synthesis of C₈H₁₀O₂

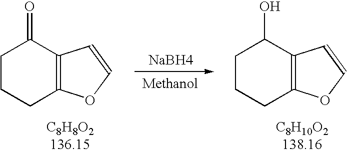

To a 250 milliliter round-bottom flask is added 6,7-dihydro-4(5H)benzo-furanone in 100 milliliters methanol. The mixture is cooled to 0 degrees C. and portion-wise is added Sodium Borohydride with stirring until the starting material is consumed. The material is then concentrated by rotary evaporation under vacuum (‘Rotovapped’) to obtain a light brown viscous liquid. The material is then purified by being chromatographed using 20% ethyl acetate/hexane to obtain a light brown viscous oil.

### Example 13

### Synthesis of C₈H₁₀O

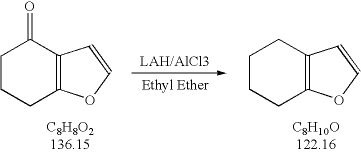

To a 250 milliliter round-bottom flask containing a solution of Lithium Aluminum Hydride in dry diethyl ether (Et₂O) is added dropwise a solution of Aluminum Chloride (AlCl₃) in Et₂O. Dropwise is added a solution of 6,7-dihydro-4(5H)benzo-furanone in Et₂O. The solution is stirred at room temperature for 2 hours. When analysis by TLC shows consumption of starting material (eluent 5% ethyl acetate/hexane), the reaction is halted with a portion of 20:50 water and 6N sulfuric acid. The product is then extracted using two portions of Et₂O and the combined organic phases are then washed once with a portion of water and once with brine. The Et₂O is largely removed by rotary evaporation under vacuum to a colorless liquid. This liquid is chromatographed using hexanes to obtain the product, 4,5,6,7 tetrahydro oxaindene as a colorless liquid.

### Example 14

### Synthesis of 3-hydroxymethyl-7-methyl-9-oxabicyclo[4.3.0]non-3-ene (14B)

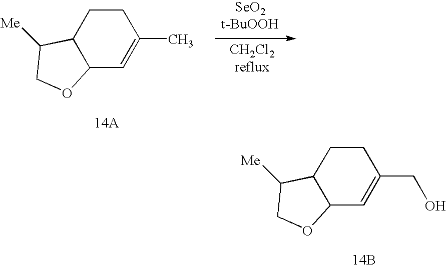

Dill ether, (14A), obtained from natural sources by known methods such as by the method of Brunke (J. Essent. Oil Res. (1991) 3(4) 257-67.) or synthesized by methods known in the art such as described by Sylvia, et al. (J. High Resolut. Chromatogr. (1998) 21(3) 185-188.), is dissolved in a portion of dry methylene chloride (CH₂Cl₂) and selenium dioxide (15 mol %) is added. The reaction is stirred at reflux for one hour and then two equivalents of tert-butyl hydroperoxide is added and the stirring is continued for an additional two days. The progress of the reaction is followed by thin-layer chromatography (TLC). The reaction is then stirred with a portion of 15% NaOH, the layers are separated and the organic layer is washed with a saturated solution of sodium sulfite twice. Flash chromatography provides the alcohol 14B.

### Example 15

### Synthesis of 4,9-dimethyl-7-oxabicyclo[4.3.0]non-1(9)-ene (15B)

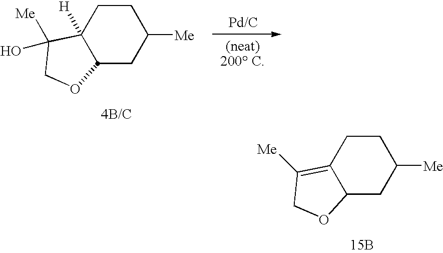

A portion of 7-hydroxy, 3,7-dimethyl-9-oxabicyclo[4.3.0]nonane (4B/C) is distilled neat at atmospheric pressure from a portion of Pd/C. The temperature is held between 200 and 230 degrees C. until no further material distills. The product obtained is 4,9-dimethyl-7-oxabicyclo[4.3.0]non-1 (9)-ene (15B).

### Example 16

### Synthesis of 3,6 dimethyl benzo[b]furan (16A)

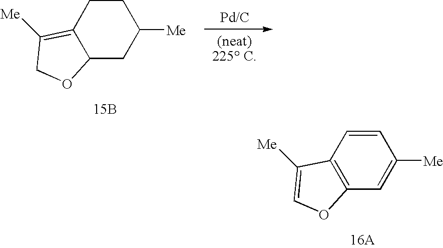

A portion of is 4,9-dimethyl-7-oxabicyclo[4.3.0]non-1(9)-ene (15B) is heated neat at atmospheric pressure over a portion of Pd/C. The temperature is held between 200 and 230 degrees C. until no further hydrogen gas evolves. The material is filtered, then is purified by column chromatography (pentane). The product obtained is 4,9-dimethyl-7-oxabicyclo[4.3.0]non-1(9)-ene (16A).

### Example 17

### Syntheses of (17B) and (17C)

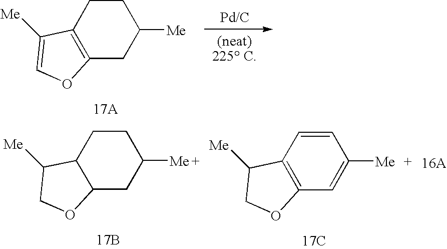

A portion of menthofuran (17A) is heated neat at atmospheric pressure over a portion of Pd/C. The temperature is held between 200 and 230 degrees C. for 4 hours. The material is filtered, and then is purified by column chromatography (pentane, then 1% ethyl acetate in pentane). The product obtained is 4,9-dimethyl-7-oxabicyclo [4.3.0]nonane (17B) 3,6 dimethyl, 2,3-dihydrobenzo[b]furan (17C).

### Example 18

### Time to Death

Time to death is another parameter that is investigated. Some active compounds are slower than others. For example, with the formate esters, death occurred in 10-20 minutes except at or below the LD₅₀ concentration. In contrast, with most of the (9-heterobicyclo[4.3.0]) analogs and commercial products, some insects persisted for hours, and there is a divergence between the 4 hr LD₅₀ and the 24 hr LD₅₀. In most cases however, if the insect was not dead by 24 hours, it would not succumb to that particular concentration at all. Some examples are given below.

A formula is made from: 5% (9-heterobicyclo[4.3.0]), 45% propyl formate and 55% ethylene glycol diformate. This material is put into a pump trigger spray and sprayed onto an absorbent surfaces (in this case a piece of drywall) and placed in the presence of cockroaches, a dose of 0.01 grams to a group of 5 roaches in a 0.5 liter jar. All roaches are immobilized in less than 30 minutes and all movement stops (our endpoint which we call “death”) within 1 hour.

### Example 19

### Synthesis of 7-oxabicyclo[4.1.0]hept-2-yl)propan-1-ol (19C)

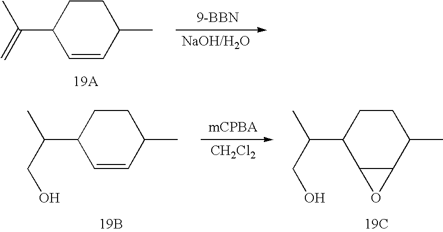

To a stirred, solution of isolimonene 19A (1.0 eq.) in tetrahydrofuran (THF) portion wise is added 9-BBN (1.0 eq.). This mixture is stirred at room temperature overnight and the reaction is judged to be complete by TLC. A small amount of water is added and the contents are concentrated in vacuo. The residue is partitioned between ethyl acetate and brine. The organic layer is washed with saturated sodium bicarbonate and brine, is dried under magnesium sulfate, is filtered, and is re-concentrated to a crude oil. The resulting mixture is purified by column chromatography on silica gel to give 19B. To a stirred, solution at −14° C. of 19B in CH₂Cl₂ is added m-CPBA (1.0 equiv.). The solution is allowed to warm to room temperature over 2.5 hours. The reaction is quenched by the addition of saturated sodium hydrogen carbonate and the product is extracted with CH₂Cl₂. The combined organic layers are washed with brine, dried over MgSO₄, and concentrated in vacuo. The residue is purified by column chromatography on silica gel to give 7-oxabicyclo[4.1.0]hept-2-yl)propan-1-ol (19C).

### Example 20

### Synthesis of 3,7-dimethyl-9-oxabicyclo[4.3.0]nonan-2-ol (20A).

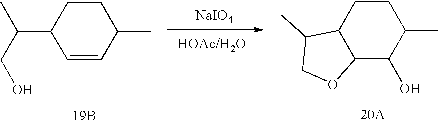

Sodium periodate near saturation is prepared by stirring in H₂O. When the solution is clear, an equal portion of glacial acetic acid (HOAc) is added slowly, with gentle stirring, which is followed by a portion of THF. The solution should remain clear with no precipitate. A portion of alkene 19B, is added in additional THF, and the reaction is heated to 40° C. overnight. The initially clear solution gradually thickens and darkens with a precipitate. When the starting material is consumed as judged by TLC, the stirring is stopped and the THF is removed by rotary evaporation. A portion of ethyl acetate (EtOAc) is added, the solution is filtered under vacuum, and the filtrate washed with water to remove the acetic acid. The combined organic layers are concentrated and flashed giving the product 3,7-dimethyl-9-oxabicyclo[4.3.0]nonan-2-ol (20A).

### Example 21

### Synthesis of 3,7-dimethyl-9-oxabicyclo[4.3.0]nonan-2-one (21A).

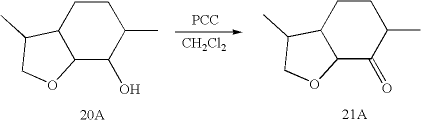

Pyridinium Chlorochromate (PCC) (1.25 eq.) is dissolved in a portion of dry methylene chloride, and sodium acetate crystals are added as a solid phase buffer. Then the oxabicyclic alcohol 20A is added dropwise with vigorous stirring. The reaction turns black and the starting alcohol is consumed as judged by TLC analysis. The crude mixture is filtered through a plug of Florisil to give a pale yellow solution which is concentrated under vacuum and then is chromatographed to give the ketone, 3,7-dimethyl-9-oxabicyclo[4.3.0]nonan-2-one (21A).

### Example 22

### Synthesis of 1,9-dibromo-4,9-dimethyl-7-oxabicyclo[4.3.0]nonane (22A).

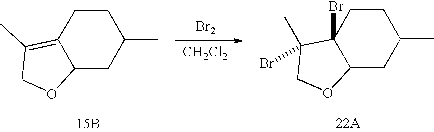

4,9-dimethyl-7-oxabicyclo[4.3.0]non-1(9)-ene (15B) is dissolved in CH₂Cl₂ is cooled to 0° C. and bromine (Br₂) is added dropwise over the period of one hour. When addition is complete, the material is washed with brine, and the solvent is removed to yield the dibromide, of 1,9-dibromo-4,9-dimethyl-7-oxabicyclo[4.3.0]nonane (22A).

In a manner similar to Example 22, using the appropriate starting materials, Examples 23 and 24 are made.

### Example 23

### Synthesis of (23A)

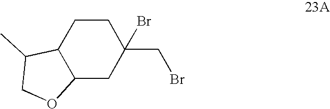

### Example 24

### Synthesis of (24A)

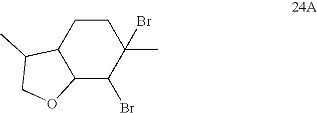

### Example 25

### Synthesis of 4-methyl-7-oxabicyclo[4.3.0]non-3-ene (25A)

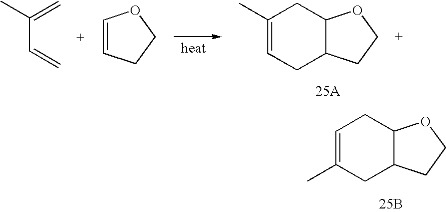

Commercially-available (Aldrich Chemical Company) isoprene and 2,3-dihydrofuran are combined and heated. A Diels-Alder reaction ensues and 4-methyl-7-oxabicyclo[4.3.0]non-3-ene (25A) and (25B) are isolated.

### Examples 26-31

A Diels-Alder reaction substantially similar to Example 25, with the appropriate choice of starting materials gives the products 26A, 27A, 28A, 29A, 30A and 31A.

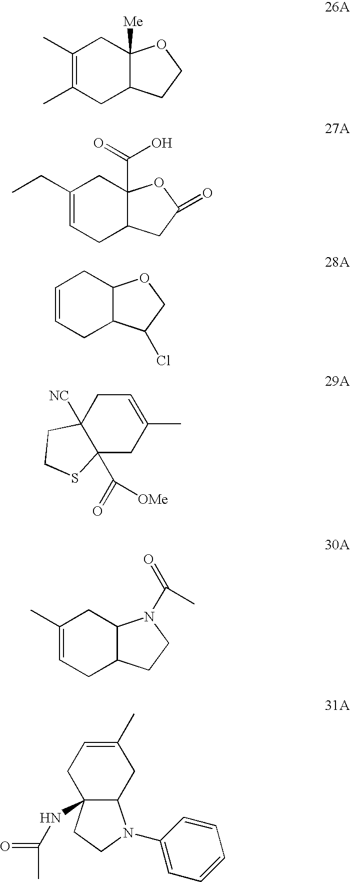

### Example 32

### Synthesis of 4-methyl-7-oxabicyclo[4.3.0]nona-1(6),3-diene(32A).

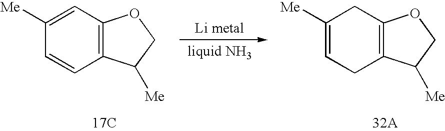

Compound 17C is subjected to Birch reduction conditions by placing a portion of it in a round-bottomed flask and cooling it to −78° C. Ammonia (NH₃) is admitted, which liquefies at that temperature and is kept from evaporating by the attachment of a cold-finger condenser. Lithium (Li) metal in excess is added to the flask carefully until the persistence of a blue color. The flask is brought to reflux and absolute ethanol is slowly added and the ammonia allowed to evaporate overnight. The residue is carefully partitioned between 1:1 hexanes: diethyl ether and water. The organic layer is washed with brine and filtered over sodium sulfate. Concentration in vacuo gives the crude product, which is purified by chromatography to give 4-methyl-7-oxabicyclo[4.3.0]non-2,5-diene(32A).

### Examples 33-35

A Birch reduction using conditions substantially similar to Example 32, with the appropriate choice of starting materials gives the products 33A, 34A, 35A.

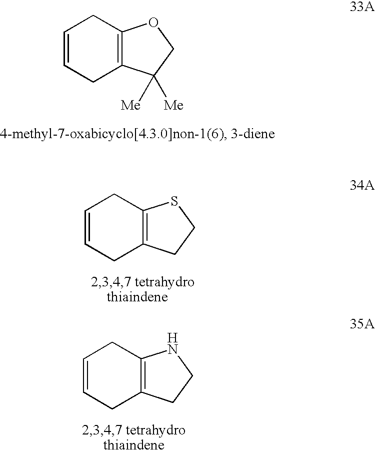

The appropriate reactions for the synthesis of the compounds of this invention, along with reaction conditions, are readily available to those of ordinary skill in the art and can be found in texts such as Vogel's Textbook of Practical Organic Chemistry (5^{th} Edition), John Wiley and Sons, NY, ISBN 0-582-46236-3, with the exception that the oxidative cyclization reaction conditions to prepare ring systems such as the oxabicyclic [4.3.0] ring system using sodium periodate in acetic acid solutions is new. However, a similar reaction is known using other reagents, such as the method employing toxic thallium salts. (See Brocksom, Ursula et al., “Enantioselective syntheses of the linden ethers,” J. Braz. Chem. Soc., 7(5), 237-242 (1996) Dep. Quim., UFSCar, Sao Carlos, Brazil.)

### Example 36

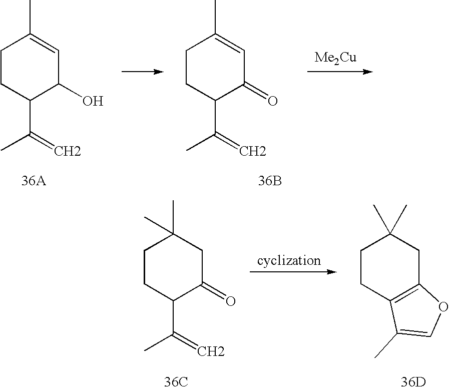

Compound 36A, available naturally or by the oxidation of limonene with chromium aluminophosphate is oxidized according to the method of Example 21 and then treated with a cuprate species, as described in Vogel, then cyclized as described in the literature to give the product 36D, illustrating that disubstitution by lower-molecular weight alkyl groups and halogens at this and all methylene units of the heterobicycles is specifically contemplated. (See also Lempers, H. E., et al., “Allylic oxidation of olefins to the corresponding alpha, beta-unsaturated ketones catalyzed by chromium aluminophosphate-5,” Appl. Catal., A 143 (1) 137-143 (1996) Laboratory of Organic Chemistry and Catalysis, Delft University of Technology, Julianalaan 136, BL Delft, Neth.)

### Example 37

### Formulation with One Heterobicyclo Compound

A formula is created by the admixture of 2% menthofuran, 55% propyl formate and 43% ethyl alcohol. This mixture is placed in aerosol cans and pressurized with a propane/butane mixture to an internal pressure of 75 pounds per square inch. This formula, when sprayed on insects of the peripleneta species, results in knockdown in under 5 seconds. When administered in the vapor phase according to Example 1, in a 2L jar, 50 microliters of the formula in the vapor phase kills all the insects in one hour. This mixture (in a 2L jar) has an LD₅₀ of approximately 20 microliters per liter.

### Example 38

### Formulation with Two Heterobicyclo Compounds

A formula is created by the admixture of 1.2% (+) Limonene Oxide and 0.95% 1,8 Cineole, 50% propyl formate and the remainder ethyl alcohol. This mixture is placed in aerosol cans and pressurized with carbon dioxide as propellant. This material, when sprayed on insects of the peripleneta species, results in knockdown in under 20 seconds. When administered in the vapor phase according to Example 1, in a 500 milliliter jar, 22 microliters of the formula in the vapor phase kills all the insects in one hour. This actives in this mixture have an LD₅₀ of approximately 11 microliters each in a 500 milliliter jar.

### Example 39

### Formulation with Diformate

A formula is created consisting exclusively of ethylene glycol diformate. This diformate is placed in aerosol cans and pressurized with carbon dioxide as propellant. This material, when sprayed on insects of the blattella species, results in knockdown in under 30 seconds. When administered in the vapor phase according to Example 1, in a 500 milliliter jar, 15 microliters of the formula in the vapor phase kills all the insects in one hour. This active has an LD₅₀ of approximately 7.5 microliters in a 500 milliliter jar, is odorless, and does not etch plastic.

### Example 40

### Formulation with One Heterobicyclo Compound and Two Formates

A formula is created by the admixture in a ratio of 1:1:1 of menthofuran, methyl formate and ethyl formate. When administered in the vapor phase according to Example 1, in a 500 milliliter jar, 15 microliters of the formula in the vapor phase kills 100% of the insects in twenty minutes. This mixture (in a 500 milliliter jar) has an LD₁₀₀ of approximately 30 microliters per liter.

### Example 41

### Formulation with One Heterobicyclo Compound and One Diformate, with an Additive (Pulegone)

A formula is created by the admixture of 2% menthofuran, 2% pulegone and 96% butylene glycol diformate. This mixture is placed in aerosol cans and pressurized with a propane/butane mixture to an internal pressure of 75 pounds per square inch. This material, when sprayed on insects of the blattella species, results in knockdown in under 15 seconds. When administered in the vapor phase according to Example 1, in a 2 liter jar, 50 microliters of the formula in the vapor phase kills all the insects in one hour. This mixture (in a 2 liter jar) has an LD₅₀ of approximately 7.2 microliters per liter.

### Comparative Example 2

### Comparative Formulation

Raid (#271) Roach and Ant Killer and Treatment is purchased and repeatedly tested in the assay of Example 1, and in a direct contact test. It did knowndown both the peripleneta species (17.2+/−3.2 seconds) and the blattella species (kill time 16 seconds) when directly sprayed on the insects.

However, in the assay of Example 1, no measurable LD₅₀ can be obtained. At 352 milligrams/500 milliliters (the highest concentration tested and 48 times higher than the above example) only 40% of the insects were dead in 24 hours. At this amount in the 500 milliliter jar assay the paper became so saturated with liquid that going any higher risks dripping the formulation directly on the insects.

1. A composition for killing insects comprising an active compound selected from the group consisting of:
A) a bicyclic heterocyclic compound having at least 7 carbons and at most 20 carbons, wherein the bicyclic heterocyclic compound has at least one heteroatom in one of the rings;
B) an ester selected from the group consisting of
i) a low molecular weight ester having the formula 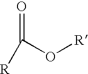
wherein R is independently selected from the group consisting of a hydrogen atom and a lower alkyl group, and R′ is selected from the group consisting of a hydrogen atom, an alkyl group, and a cycloalkyl group; and
ii) a low molecular weight diester having the formula: 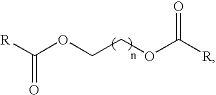
wherein n is from about 1 to about 4; and
C) combinations thereof,
wherein the composition in its vapor phase kills insects.

2. The composition of claim 1, wherein component A) is selected from the group consisting of 9-oxabicyclo[4.3.0]nonyl, 9-thiabicyclo[4.3.0]nonyl, 9-azabicyclo[4.3.0]nonyl, 2-oxabicyclo[3.3.0]octyl, 2-oxabicyclo[2.2.2]octyl, 2-thiabicyclo[3.3.0]octyl, 2-azabicyclo[3.3.0]octyl, 7-oxabicyclo[4.1.0]heptyl, 7-oxabicyclo[2.2.1]heptyl compounds, and combinations thereof.

3. The composition of claim 2, wherein the 7-oxabicyclo[4.1.0]heptyl compound is selected from the group consisting of limonene oxide and isolimonene oxide; the 2-oxabicyclo[2.2.2]octyl compound is selected from the group consisting of 1,8 cineoles, and the 7-oxabicyclo[2.2.1]heptyl compound is selected from the group consisting of 1,4 cineoles.

4. The composition of claim 2, wherein component A) comprises a 9-heterobicyclo[4.3.0] analog of formula: 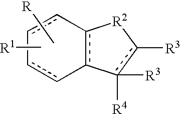
wherein each R is independently selected from the group consisting of a hydrogen atom, a haloalkyl group, and a lower alkyl group,
R¹ is selected from the group consisting of a hydrogen atom, a haloalkyl group, and a heteroatom group,
R² is a heteroatom,
each R³ is independently selected from the group consisting of a hydrogen atom, a haloalkyl group, and a lower alkyl group, and
R⁴ is selected from the group consisting of a hydrogen atom, a heteroatom group, and a haloalkyl group.

5. The composition of claim 1, wherein component A) is selected from the group consisting of 5-oxo-9-oxabicyclo[4.3.0]nona-1,(6),7-diene-7-carboxylic acid, (+) menthofuran, methyl 5-oxo-9-oxabicyclo[4.3.0]nona-1,(6),7-diene-7-carboxylate, 3-(hydroxymethyl)-4,5,6,7-tetrahydrooxainden-4-ol, methyl 5-hydroxy-9-oxabicyclo[4.3.0]nona-1,(6),7-diene-7-carboxylate, 3,6-dimethyl-3a,4,5,7a-tetrahydrocoumaran, 3,6-dimethylcoumaran, and combinations thereof.

6. The composition of claim 1, wherein component B) is selected from the group consisting of methyl propionate, methyl acetate, ethyl propionate, ethyl valerate, methyl butyrate, 1,2 propylene glycol diformate, ethyl butyrate, ethylene glycol diformate, propyl butyrate, butyl formate, n-propyl acetate, propyl formate, ethyl formate, butyl propionate, hexyl acetate, propyl propionate, pentyl acetate, methyl valerate, hexyl formate, heptyl formate, pentyl formate, tert-butyl formate, methyl formate, tert-butyl acetate, iso-propyl acetate, 1,3-propylene glycol diformate, n-butyl acetate, cyclopentyl formate, ethyl acetate, 1,3-propylene glycol diformate, and combinations thereof.

7. The composition of claim 1, further comprising an optional ingredient selected from the group consisting of an alcohol; oils and extracts and steam distillates of natural products containing component A); racemates and diastereomers of component A) made by synthetic processes; contact insecticides; traditional carriers; propellants; and combinations thereof.

8. A method for killing insects comprising spraying the composition of claim 1 on a surface.

9. The method of claim 8, wherein the surface is an absorbent material.

10. The method of claim 9, wherein the absorbent material is selected from the group consisting of paper, cloth, woods of all sorts, plaster, drywall, hair, fur, dirt, dust, and objects composed thereof, living or non-living, indoors or outdoors.

11. A method for testing vapor phase insecticide activity comprising:
1) adding a composition to be tested for vapor phase insecticide activity to a container, wherein the container contains at least one insect, and wherein the container is configured such that the insect is not forced to contact the composition in any form other than vapor phase of the composition, and wherein the container is configured such that the composition cannot escape the container during the method.

12. The method of claim 11, further comprising:
2) periodically monitoring the insect after step 1) to classify condition of the insect.

13. The method of claim 12, wherein there are at least 2 insects in the container and wherein the method further comprises:
3) determining an LD₅₀ for the composition based on amount of the composition required for 50% mortality at a specified time.

14. A heterobicyclic compound of formula: 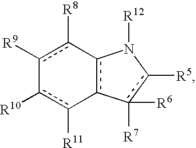
wherein R⁵ is selected from the group consisting of a hydrogen atom, a lower alkyl group, and a haloalkyl group;
R⁶ is selected from the group consisting of a hydrogen atom, a lower alkyl group, and a haloalkyl group;
R⁷ is selected from the group consisting of a hydrogen atom, a heteroatom group, a lower alkyl group, and a haloalkyl group;
R⁸, R⁹, R¹⁰, and R¹¹, are each independently selected from the group consisting of halo, a hydrogen atom, a heteroatom group, a haloalkyl group, and a lower alkyl group; and
R¹² is selected from the group consisting of a hydrogen atom and a lower alkyl group, wherein when R¹² is a hydrogen atom, both rings are saturated, and R⁸, R¹⁰, and R¹¹ are hydrogen atoms, then either R⁶ and R⁷ are both not methyl groups or R⁹ is not a methyl group.

15. A heterobicyclic compound of formula: 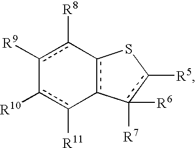
wherein R⁵ is selected from the group consisting of a hydrogen atom, a lower alkyl group, and a haloalkyl group;
R⁶ is selected from the group consisting of a hydrogen atom, a lower alkyl group, and a haloalkyl group;
R⁷ is selected from the group consisting of a hydrogen atom, a heteroatom group, a lower alkyl group, and a haloalkyl group; and
R⁸, R⁹, R¹⁰, and R¹¹, are each independently selected from the group consisting of halo, a hydrogen atom, a heteroatom group, a haloalkyl group, and a lower alkyl group; and wherein when R⁸, R¹⁰, and R¹¹ are hydrogen atoms, then either R⁶ and R⁷ are both not methyl groups or R⁹ is not a methyl group.

16. A heterobicyclic compound of formula: 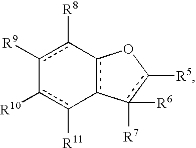
wherein R⁵ is selected from the group consisting of a hydrogen atom, a lower alkyl group, and a haloalkyl group;
R⁶ is selected from the group consisting of a hydrogen atom, a lower alkyl group, and a haloalkyl group;
R⁷ is selected from the group consisting of a hydrogen atom, a heteroatom group, a lower alkyl group, and a haloalkyl group; and
R⁸, R⁹, R¹⁰, and R¹¹, are each independently selected from the group consisting of halo, a hydrogen atom, a heteroatom group, a haloalkyl group, and a lower alkyl group; and with the provisos that:
when R⁶, R⁷, and R⁹ are all hydrogen atoms, then at least one of R⁸, R¹⁰, and R¹¹ is selected from the group consisting of halo, a haloalkyl group, and a heteroatom group;
when R⁷ is a hydrogen atom and R⁶ and R⁹ are both methyl groups, then at least one of R⁸, R¹⁰, and R¹¹ is selected from the group consisting of halo, a haloalkyl group, and a heteroatom group; and
when R⁶ is a hydrogen atom and R⁷ and R⁹ are both methyl groups, then at least one of R⁸, R¹⁰, and R¹¹ is selected from the group consisting of halo, a haloalkyl group, and a heteroatom group.
